(19) United States
(12) Patent Application Publication
(10) Pub. No.: US 2010/0309108 A1
(43) Pub. Date: Dec. 9, 2010

(54) LIQUID CRYSTAL DISPLAY DEVICE

(75) Inventors: Yoshihisa OOISHI, Yokohama (JP); Ikuko Imajo, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/792,886

(22) Filed: Jun. 3, 2010

(30) Foreign Application Priority Data
Jun. 5, 2009 (JP) 2009-135916

(51) Int. Cl. G09G 3/36

(52) U.S. Cl. 345/100

(57) ABSTRACT

A liquid crystal display device includes: a drive circuit; and a plurality of divided display sections which are arranged parallel to each other in a predetermined direction. Each divided display section includes: a plurality of scanning lines which are arranged parallel to each other in the predetermined direction; a plurality of data signal lines, and a plurality of pixel circuits which are provided correspondingly to intersections of the scanning lines and the data signal lines . The drive circuit supplies a signal potential to the data signal line based on a data signal before selecting the scanning line which is included in one or more of the divided display sections, is arranged adjacent to the scanning line included in another divided display section, and is firstly selected and within a blanking period.

### CROSS-REFERENCE TO RELATED APPLICATION

The present application claims priority from Japanese application JP2009-135916 filed on Jun. 5, 2009, the content of which is hereby incorporated by reference into this application.

### BACKGROUND OF THE INVENTION

1. Field of the Invention

The present invention relates to a liquid crystal display device, and more particularly to a liquid crystal display device in which a display screen is divided into a plurality of sections and the sections are driven respectively.

2. Description of the Related Art

Recently, to enhance the display quality of a liquid crystal display device which uses thin film transistors, there have been proposed double frame rate displays which can halve 1 frame period composed of a period for writing image data and a vertical blanking period compared to a conventional 1 frame period. In this case, a writing period per 1 scanning line is shortened thus giving rise to a possibility that defective writing occurs when the number of scanning lines is large or the like. As a method which ensures the writing period, the development of a technique which divides a display screen into a plurality of sections and drives the divided sections independently (hereinafter referred to as “division driving method”) is underway.

FIG. 1 shows one example of the constitution of a liquid crystal display device which adopts a division driving method. The liquid crystal display device includes a display control unit TC, an upper divided display section DAH, a lower divided display section DAL, an upper data line drive circuit XDVH, a lower data line drive circuit XDVL, and a vertical drive circuit YDV. Here, a display region of the liquid crystal display device is constituted of the upper divided display section DAH and the lower divided display section DAL.

The upper divided display section DAH includes m pieces of scanning lines GL₁ to GLₘ, a plurality of upper data signal lines DLH which intersect with the m pieces of scanning lines GL₁ to GLₘ, and a plurality of pixel circuits PC which are provided correspondingly to intersections between the m pieces of scanning lines GL₁ to GLₘ and the upper data signal lines DLH. The respective upper data signal lines DLH are connected to the upper data line drive circuit XDVH. The lower divided display section DAL includes m pieces of scanning lines GLₘ₊₁ to GL₂ₘ, a plurality of lower data signal lines DLL which intersect with the m pieces of scanning lines GLₘ₊₁ to GL₂ₘ, and a plurality of pixel circuits PC which are provided correspondingly to intersections between the m pieces of scanning lines GLₘ₊₁ to GL₂ₘ and the lower data signal lines DLL. Here, the plurality of pixel circuits PC are not shown in FIG. 1. The respective lower data signal lines DLL are connected to the lower data line drive circuit XDVL. Here, the scanning line GLₖ indicates the k-th scanning line counted from the top in the display region, and numeral is not added to reference character GL when it is unnecessary to specify the order of the scanning lines. The respective scanning lines GL included in the upper divided display section DAH and the lower divided display section DAL are connected to the vertical drive circuit YDV.

In the upper divided display section DAH, the vertical drive circuit YDV sequentially selects the scanning lines GL from the scanning line GL₁ and, after driving the scanning line GLₘ, repeats the selection of the scanning lines GL starting from the scanning line GL₁ again by way of a vertical blanking period. A period during which any one of the scanning lines GL is selected is a writing period. During the writing period, the upper data line drive circuit XDVH supplies a data signal. The data signal indicates gray level to be displayed by the pixel circuit PC corresponding to the upper data signal line DLH and the selected scanning line GL in the form of the level of the potential to the upper data signal line DLH. In the same manner, in the lower divided display section DAL, the vertical drive circuit YDV sequentially selects the scanning lines GL from the scanning line GLₘ₊₁ and, after driving the scanning line GL₂ₘ, repeats the selection of the scanning lines GL starting from the scanning line GLₘ₊₁ again by way of the vertical blanking period. During the writing period, the lower data line drive circuit XDVL supplies a data signal. The data signal indicates gray level to be displayed by the pixel circuit PC corresponding to the lower data signal line DLL and the selected scanning line GL to the lower data signal line DLL.

JP 2008-70406 A discloses an example of a conventional liquid crystal display device which uses the above-mentioned division drive method. JP 11-15448 A discloses the invention relating to the present application. The invention disclosed in JP 11-15448 A does not employ the division drive method. That is, JP 11-15448 A discloses a liquid crystal display device having a pixel circuit in which precharge is premised, wherein display data for precharge is outputted to a data signal line during a vertical blanking period.

In the conventional liquid crystal display device which uses the division drive method, a data signal is not supplied during the vertical blanking period. Accordingly, as in the case of the scanning line GLₘ₊₁ included in the lower divided display section DAL, at timing when the scanning line which is selected immediately after the vertical blanking period is selected, a potential of the data signal line is changed toward a potential which the data signal indicates from a fixed potential (for example, a potential providing a lowest gray level) applied during the vertical blanking period. On the other hand, as in the case of the scanning line which is selected following an arbitrary scanning line after the vertical blanking period such as the scanning line GLₘ₊₂ included in the lower divided display section DAL and the scanning line GLₘ included in the upper divided display section DAH, a potential of the data signal line is changed toward a potential which a present data signal indicates from a potential changed in response to a preceding data signal. Due to the difference in the manner that the potential of the data signal line changes, the input-output characteristic between the data signal and the gray level to be displayed differs between the pixel corresponding to the scanning line selected immediately after the vertical blanking period and the pixel corresponding to the scanning line selected thereafter.

This difference in characteristic gives rise to a serious drawback when a division display is performed. When a display screen is divided into a plurality of divided display sections, with respect to the scanning line which is arranged adjacent to a boundary of the divided display section and is selected immediately after the vertical blanking period, that is, the above-mentioned scanning line GLₘ₊₁, on both sides of the pixel which corresponds to the scanning line GLₘ₊₁, pixels which differ in characteristic from each other are arranged. Accordingly, the difference in gray level attributed to the difference in characteristic is easily recognized.

### SUMMARY OF THE INVENTION

The invention has been made in view of the above-mentioned drawbacks, and it is an object of the invention to provide a technique which approximates an input-output characteristic between gray level displayed by a pixel circuit corresponding to a scanning line which is arranged adjacent to a boundary of a divided display section and is selected immediately after a vertical blanking period and a data signal to an input-output characteristic between gray level corresponding to other scanning line and the data signal.

To briefly explain the summary of typical inventions among the inventions disclosed in this specification, they are as follows.

(1) According to one aspect of the invention, there is provided a liquid crystal display device which includes: a drive circuit; and a plurality of divided display sections which are arranged parallel to each other in a predetermined direction. Each divided display section includes: a plurality of scanning lines which are connected to the drive circuit; a plurality of data signal lines which intersect with the plurality of scanning lines, and are connected to the drive circuit; and a plurality of pixel circuits which are provided correspondingly to intersections of the scanning lines and the data signal lines, the pixel circuit displaying gray level based on a data signal which is supplied when the corresponding scanning line is selected and is supplied to the corresponding data signal line. The drive circuit sequentially selects the plurality of scanning lines included in each divided display section from the first scanning line, supplies the data signal to the data signal line included in the divided display section, and repeats the operations from the first scanning line with a lapse of a predetermined period after selecting the last scanning line. The drive circuit supplies a signal potential to the data signal line based on the data signal before selecting the first scanning line which is included in at least one of the divided display sections and is arranged adjacent to the scanning line included in another divided display section and within the predetermined period.

(2) In the liquid crystal display device having the constitution (1) , the plurality of scanning lines included in each divided display section are arranged in the predetermined direction in order that the scanning lines are selected by the drive circuit, and the drive circuit supplies the signal potential to the data signal line which is included in one or more of the divided display section based on the data signal which is supplied at the time of selecting at least one of the scanning lines included in another divided display section before selecting the first scanning line which is included in the one or more of the divided display sections and is arranged adjacent to the scanning line included in another divided display section and within the predetermined period.

(3) In the liquid crystal display device having the constitution (2), the drive circuit supplies the signal potential to the data signal line which is included in one or more of the divided display section based on the data signal which is supplied at the time of selecting the last scanning line which is included in another divided display section before selecting the first scanning line which is included in the one or more of the divided display sections and is arranged adjacent to the scanning line included in another divided display section and within the predetermined period.

(4) In the liquid crystal display device having the constitution (1), the drive circuit supplies the signal potential to the data signal line which is included in one or more of the divided display section based on the data signal which is supplied at the time of selecting the first scanning line which is included in the one or more of the divided display sections and is arranged adjacent to the scanning line included in another divided display section before selecting the first scanning line and within the predetermined period.

According to the invention, it is possible to approximate the characteristic between the gray level displayed by the pixel circuit corresponding to the scanning line which is arranged adjacent to a boundary of the divided display section and is selected immediately after the vertical blanking period and the data signal to the characteristic between gray level corresponding to other scanning line and the data signal.

### BRIEF DESCRIPTION OF THE DRAWINGS

FIG. 1 is a circuit diagram showing the constitution of a liquid crystal display device adopting a division drive method;

FIG. 2 is a block diagram showing an equivalent circuit of one pixel circuit;

FIG. 3 is a view showing the constitution of a frame period according to a first embodiment;

FIG. 4 is a timing chart showing timing of various signals used in the first embodiment;

FIG. 5 is a view showing the constitution of a frame period according to a second embodiment; and

FIG. 6 is a timing chart showing timing of various signals used in the second embodiment.

### DESCRIPTION OF THE PREFERRED EMBODIMENTS

Hereinafter, embodiments of the invention are explained in conjunction with drawings. In these embodiments described hereinafter, the invention is applied to an IPS liquid crystal display device. Further, among constitutional elements which are used in the embodiments, the constitutional elements having identical functions are given same reference characters and their repeated explanation is omitted.

### Embodiment

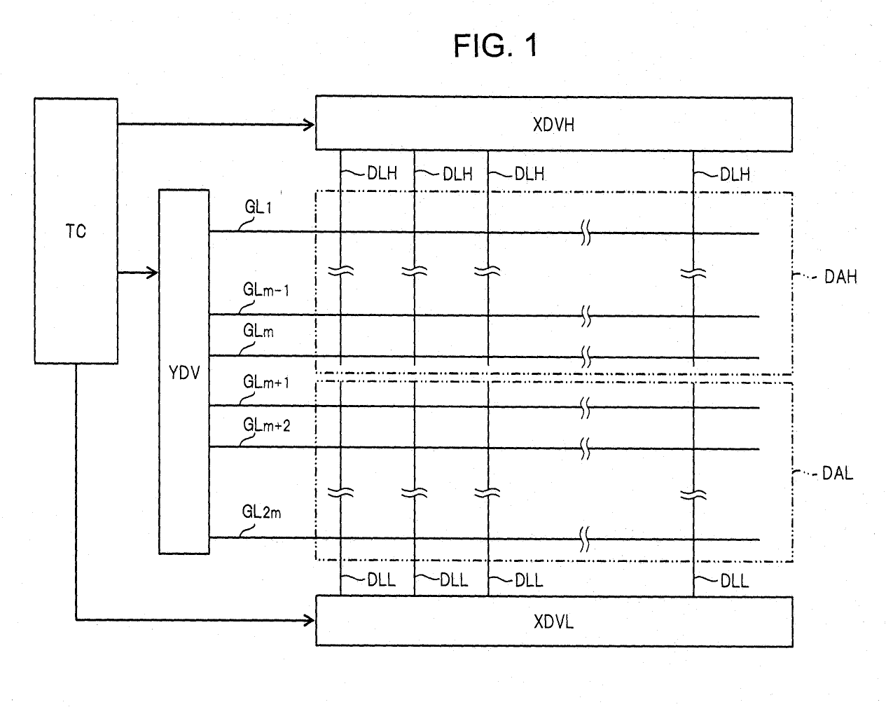

FIG. 1 is a circuit diagram showing the constitution of a liquid crystal display device according to an embodiment of the invention and is also a circuit diagram showing the constitution of the liquid crystal display device which adopts a division drive method. The liquid crystal display device includes a liquid crystal display panel. The liquid crystal display panel structurally includes an array substrate on which pixel circuits PC and the like are formed, a counter substrate which is arranged to face the array substrate in an opposed manner, liquid crystal which is filled in a space defined between the array substrate and the counter substrate and a driver IC which is connected to the array substrate. Here, a polarizer is adhered to the outside of the array substrate and to the outside of the counter substrate. When viewed from a different viewpoint, the liquid crystal display panel includes a display control unit TC, an upper divided display section DAH, a lower divided display section DAL, an upper data line drive circuit XDVH, a lower data line drive circuit XDVL, and a vertical drive circuit YDV. The display control unit TC, the upper data line drive circuit XDVH and the lower data line drive circuit

XDVL are mounted on the driver IC. The upper divided display section DAH and the lower divided display section DAL constitute a display region on the array substrate, and the lower divided display section DAL is arranged below the upper divided display section DAH in the drawing.

The upper divided display section DAH includes m pieces of scanning lines GL₁ to GLₘ, a plurality of upper data signal lines DLH which intersect with the m pieces of scanning lines GL, and a plurality of pixel circuits PC which are provided correspondingly to intersections between the m pieces of scanning lines GL and the upper data signal lines DLH. The respective upper data signal lines DLH are connected to the upper data line drive circuit XDVH. The lower divided display section DAL includes m pieces of scanning lines GLₘ₊₁ to GL₂ₘ, a plurality of lower data signal lines DLL which intersect with the m pieces of scanning lines GL, and a plurality of pixel circuits PC which are provided correspondingly to intersections between the m pieces of scanning lines GL and the lower data signal lines DLL. Here, the plurality of pixel circuits PC are not shown in FIG. 1. The respective lower data signal lines DLL are connected to the lower data line drive circuit XDVL. Here, the scanning line GLₖ indicates the k-th scanning line in a serial number form counted from the top from the upper divided display section DAH to the lower divided display section DAL. Further, numeral is not added to reference character GL when it is unnecessary to specify the order of the scanning lines. The respective scanning lines GL which are included in the upper divided display section DAH and the lower divided display section DAL are connected to the vertical drive circuit YDV. In the upper divided display section DAH and the lower divided display section DAL, common signal lines CL not shown in the drawing which correspond to the respective scanning lines GL in a one-to-one relation extend parallel to the scanning lines GL. In the explanation made hereinafter, the upper data signal lines DLH and the lower data signal lines DLL are collectively described as data signal lines DL.

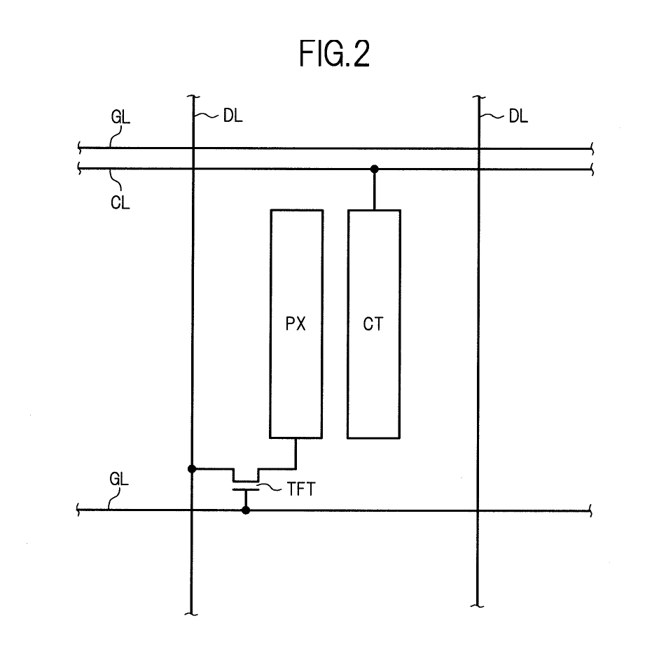

FIG. 2 is a block diagram showing an equivalent circuit of one pixel circuit PC. The pixel circuit PC is arranged in a region defined by two neighboring scanning lines GL and two neighboring data signal lines DL. Each pixel circuit PC is connected to the scanning line GL arranged on a lower side thereof and the data signal line DL arranged on a left side thereof. Each pixel circuit PC includes a thin film transistor TFT, a pixel electrode PX and a common electrode CT. The thin film transistor TFT has a source electrode thereof connected to the data signal line DL arranged on a left side of the pixel circuit PC, a drain electrode thereof connected to the pixel electrode PX, and a gate electrode thereof connected to the scanning line GL arranged on a lower side of the pixel circuit PC. Further, a capacitance is formed between the pixel electrode PX and the common electrode CT, and the polarization of liquid crystal is controlled by an electric field generated between the electrodes. The common electrodes CT are connected to the common signal line CL corresponding to the scanning line GL to which the pixel circuits PC are connected.

Display image data which is data of an image to be displayed is inputted to the display control unit TC from the outside of the liquid crystal display panel. The display control unit TC outputs display data for every row, a horizontal synchronizing signal, a clock for latching display data and the like to the upper data line drive circuit XDVH and the lower data line drive circuit XDVL thus controlling the upper data line drive circuit XDVH and the lower data line drive circuit XDVL. Further, the display control unit TC also outputs a vertical synchronizing signal, a shift clock and the like to the vertical drive circuit YDV thus controlling the vertical drive circuit YDV. The vertical drive circuit YDV supplies a selection signal to the scanning line GL to be selected, so that the thin film transistor TFT included in the pixel circuit PC connected to the scanning line GL selected in this manner is turned on. The vertical drive circuit YDV simultaneously selects one of the scanning lines GL included in the upper divided display section DAH and one of the scanning lines GL included in the lower divided display section DAL. Although the vertical drive circuit YDV is described as one circuit in FIG. 1, the vertical drive circuit

YDV may be divided into two vertical drive circuits YDV for the upper divided display section DAH and the lower divided display section DAL. The upper data line drive circuit XDVH decomposes the display data for 1 row received from the display control unit TC for each column for latching, and outputs the display data of each column to each of the upper data signal line DLH as a display data signal together with the horizontal synchronizing signal. In the same manner, the lower data line drive circuit XDVL also outputs the display data signal for each column of the row to each of the lower data signal line DLL.

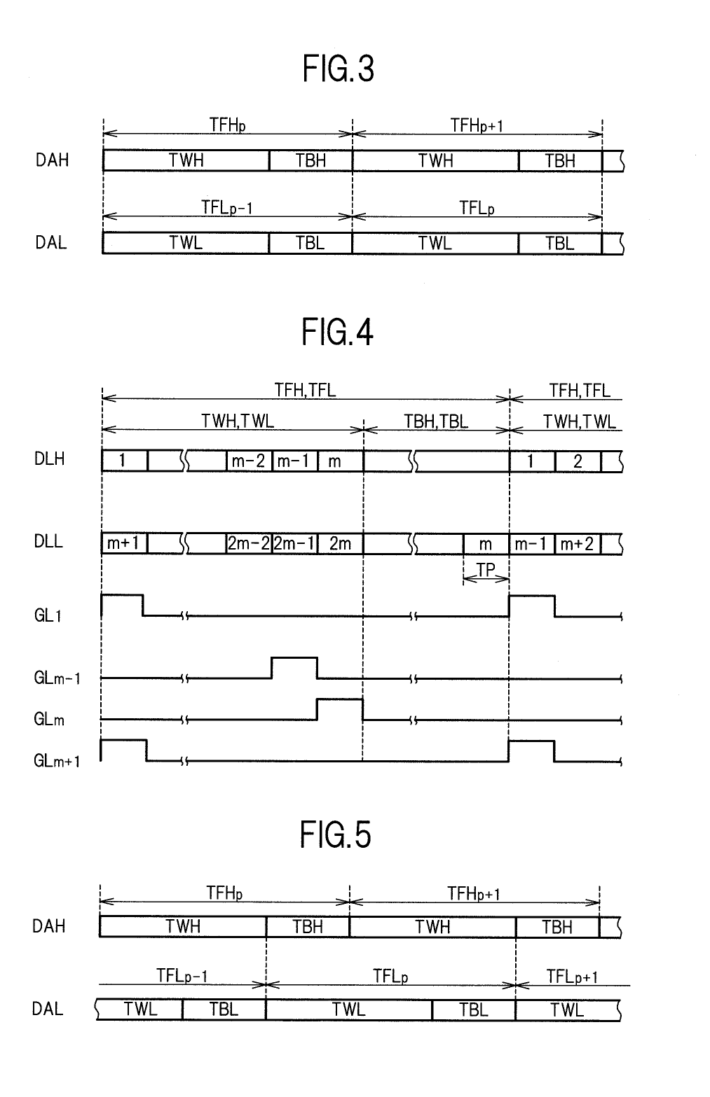

The vertical drive circuit YDV, the upper data line drive circuit XDVH and the lower data line drive circuit XDVL constitute a drive circuit which drives the pixel circuits PC included in the upper divided display section DAH and the lower divided display section DAL. The manner of operation of the drive circuit is explained in detail hereinafter. FIG. 3 is a view showing the constitution of a frame period according to the first embodiment of the invention. A frame period TFH indicated on an upper side of FIG. 3 is a period during which one still picture in the upper divided display section DAH is outputted. This period is further divided into a writing period TWH in which display data is written in the pixel circuit PC connected to the scanning line GL, and a vertical blanking period TBH. A frame period TFL indicated on a lower side of FIG. 3 is substantially equal to the frame period TFH except for a point that the frame period TFL is for the lower divided display section DAL. The frame period TFL is divided into a writing period TWL and a vertical blanking period TBL. Here, the liquid crystal display device displays a moving picture by periodically rewriting an image to be displayed. The frame period TFHₚ is a frame corresponding to a p-th image. In this embodiment, the frame period TFHₚ and the frame period TFLₚ₋₁ become the same period. That is, the upper divided display section DAH depicts a still picture which advances in time by one period compared to the lower divided display section DAL. Due to such an operation, an image of arbitrary order is sequentially written in the upper divided display section DAH from the top and, thereafter, the image of the same order is sequentially written in the lower divided display section DAL from the top, so that the deviation of a moving object at a center portion can be suppressed.

FIG. 4 is a timing chart showing timing of various signals used in the first embodiment. In the drawing, time is taken on an axis of abscissas. In the drawing, a display data signal supplied to the upper data signal line DLH, a display data signal supplied to the lower data signal line DLL, a selection signal supplied to the scanning line GL ₁, a selection signal supplied to the scanning line GLₘ₋₁, a selection signal supplied to the scanning line GLₘ, and a selection signal supplied to the scanning line GLₘ₊₁ are shown in order from the top. In FIG. 4, with respect to the display data signal supplied to the upper data signal line DLH and the display data signal supplied to the lower data signal line DLL, a content of the signal is expressed by the row number of the display data instead of the potential level. When the arbitrary scanning line GL is selected, the potential of a selection signal supplied to the scanning line GL rises, so that the thin film transistor TFT included in the pixel circuit PC connected to the scanning line GL is turned on. In these pixel circuits PC, the potential of a display data signal from the data signal line DL is supplied to the pixel electrode PX by the thin film transistor TFT so that the potential difference is generated in capacitance between the pixel electrode PX and the common electrode CT due to such a potential. When the scanning line GL is no more selected, the thin film transistor TFT is turned off, and the potential difference generated in capacitance is stored until the next selection of the scanning line GL is made. A gray level expression is performed based on the degree of polarization of liquid crystal which changes correspondingly to the stored potential difference.

A driving method of the upper divided display section DAH is explained hereinafter. During a writing period TWH in an arbitrary frame period TFH, the vertical drive circuit YDV sequentially selects the scanning lines GL from the first scanning line GL₁ to the last scanning line GLₘ in the upper divided display section DAH. Next, the next frame period TFH comes after the vertical blanking period TBH, and the selection of the scanning lines GL in the writing period TWH is repeated starting from the scanning line GL₁ again. During the writing period TWH, the upper data line drive circuit XDVH supplies a display data signal to be supplied to the pixel circuits PC which are connected to the scanning line GL to the upper data signal line DLH as the potential level. To be more specific, when the k-th scanning line GLₖ is selected, the upper data line drive circuit XDVH outputs a display data signal of the k-th row to the upper data signal line DLH. A driving method of the lower divided display section DAL is explained hereinafter. During the writing period TWL in an arbitrary frame period TFL, the vertical drive circuit YDV sequentially selects the scanning lines GL from the first scanning line GLₘ₊₁ to the last scanning line GL₂ₘ in the lower divided display section DAL. Next, the next frame period TFL comes after the vertical blanking period TBL, and the selection of the scanning lines GL in the writing period TWL is repeated again starting from the scanning line GLₘ₊₁. During the writing period TWL, the lower data line drive circuit XDVL supplies a display data signal to be supplied to the pixel circuits PC which are connected to the scanning line GL to the lower data signal line DLL as the level of potential. The driving method performed by the lower data line drive circuit XDVL is substantially equal to the driving method performed by the upper data line drive circuit XDVH with respect to the above-mentioned points. However, the lower data line drive circuit XDVL outputs the signal potential of a pre-data signal during a pre-data signal output period TP which is within the vertical blanking period TBL and immediately before the writing period TWL of the next frame period TFL. The pre-data signal, in this embodiment, has the same potential as the display data signal in the m-th row which the upper data line drive circuit XDVH outputs when the scanning line GLₘ is selected during the preceding writing period TWH. In this embodiment, a length of the pre-data signal output period TP is equal to a length of a period during which one of other scanning lines GL is selected (horizontal scanning period) .

Due to such a driving method, in the same manner as the scanning line GLₘ or the scanning line GLₘ₊₂, before the scanning line GLₘ₊₁ is selected, the display data signal is supplied to the lower data signal line DLL. Accordingly, it is possible to approximate the input-output characteristic between the gray level displayed by the row of the pixel circuits PC corresponding to the scanning line GLₘ and the display data signal to the characteristic between another scanning line GL and the data signal. This driving method of this embodiment uses the frame inversion driving and hence, the case where the frame inversion driving is used is explained more specifically. In the row of the pixel circuits PC corresponding to the scanning line GL which is not selected immediately after the vertical blanking period TBL (also vertical blanking period TBH) , the voltage change of the display data signal applied to the data signal line DL takes place continuously due to the continuity of display data. On the other hand, in the case where the pre-data signal is not supplied, the potential applied to the data signal line DL when the scanning line GLₘ₊₁ is selected becomes interrupted. However, with the supply of the pre-data signal, the potential applied to the data signal line DL becomes continuous. Accordingly, it is possible to allow the potential of the data signal line DL when the scanning line GLₘ₊₁ is selected to easily follow the display data signal, so that it is possible to suppress a phenomenon where the gray level of an image on only the scanning line GLₘ₊₁ becomes darker than the gray level of the image on the scanning lines GL above and below the scanning line GLₘ₊₁. That is, it is possible to suppress a phenomenon where a darker line appears.

Here, the pre-data signal is not limited to the above-mentioned signal. For example, it is sufficient that any relationship such as the monotonic increase is established between the gray level to be displayed (display data signal on another row) and the pre-data signal. For example, during the pre-data signal output period TP, the display data signal in the (m+1)-th row fo the pixel circuits PC supplied immediately after the pre-data signal output period TP may be outputted as the pre-data signal. Even when the row differs more or less, since the difference in the display data signal is not large due to the continuity of the display image, it is possible to obtain an advantageous effect that the characteristic between the gray level displayed by the row of the pixel circuit PC corresponding to the scanning line GLₘ₊₁ and the display data signal is made to approximate the input-output characteristic between another scanning line GL and the data signal. Further, not only the display data on one row but also the display data on a plurality of rows out of rows equal to or close to the (m+1)-th row is averaged, and the pre-data signal may be supplied with the signal potential obtained by such averaging.

This driving method is also applicable to the line inversion driving or the dot inversion driving instead of the frame inversion driving. Differently from the frame inversion driving, in the line inversion driving, the polarity of the display data signal is switched for every row. In the conventional driving method, the potential of the scanning line GLₘ₊₁ before the change takes place assumes the potential at the center of amplitude (for example, 0V). As a result, there arises a phenomenon that the brightness of the image in the row becomes higher than the brightnesses of the image in the preceding and succeeding rows. With the use of the driving method of this embodiment, it is possible to approximate the characteristic between the gray level displayed by the pixel circuit PC of the row corresponding to the scanning line GLₘ and the display data signal to the characteristic between another scanning line GL and the data signal and hence, it is possible to suppress a phenomenon that the brightness of the image in the row becomes higher than the brightnesses of the image in other rows above and below the row. In this case, the relationship between the gray level to be displayed and the pre-data signal may preferably be the monotonic decrease relationship.

### Embodiment 2

The second embodiment of the invention is explained hereinafter. The constitution of the liquid crystal display device according to the second embodiment is substantially equal to the constitution of the liquid crystal display device according to the first embodiment explained in conjunction with FIG. 1 and FIG. 2. The second embodiment differs from the first embodiment only with respect to an operation of a drive circuit of a liquid crystal display panel. Hereinafter, the explanation is made by focusing on points which make this embodiment different from the first embodiment.

FIG. 5 is a view showing the constitution of a frame period according to the second embodiment. Firstly, a frame period TFH indicated on an upper side of FIG. 5 is a period during which one picture in the upper divided display section DAH is outputted. This period is further divided into a writing period TWH and a vertical blanking period TBH. A frame period TFL indicated on a lower side of FIG. 5 is substantially equal to the frame period TFH except for a point that the frame period TFL indicated on a lower side of FIG. 5 is for a lower divided display section DAL, and is divided into a writing period TWL and a vertical blanking period TBL. Although the second embodiment is substantially equal to the first embodiment with respect to a point that the frame period TFLₚ starts after starting the frame period TFHₚ, this embodiment differs from the first embodiment with respect to a point that the frame period TFLₚ starts simultaneously with starting of the vertical blanking period of the frame period TFHₚ. Due to such an operation, when an arbitrary still picture is sequentially written in the upper divided display section DAH from the top, immediately after the still image is written in the row corresponding to the scanning line GLₘ, the still image is written in the row corresponding to the scanning line GLₘ₊₁. Accordingly, compared to the first embodiment, it is possible to more effectively suppress the deviation of a moving object at a center portion. The method of selecting the scanning line GL and the constitution which realizes the selection method are described in JP 2008-70406 A in detail.

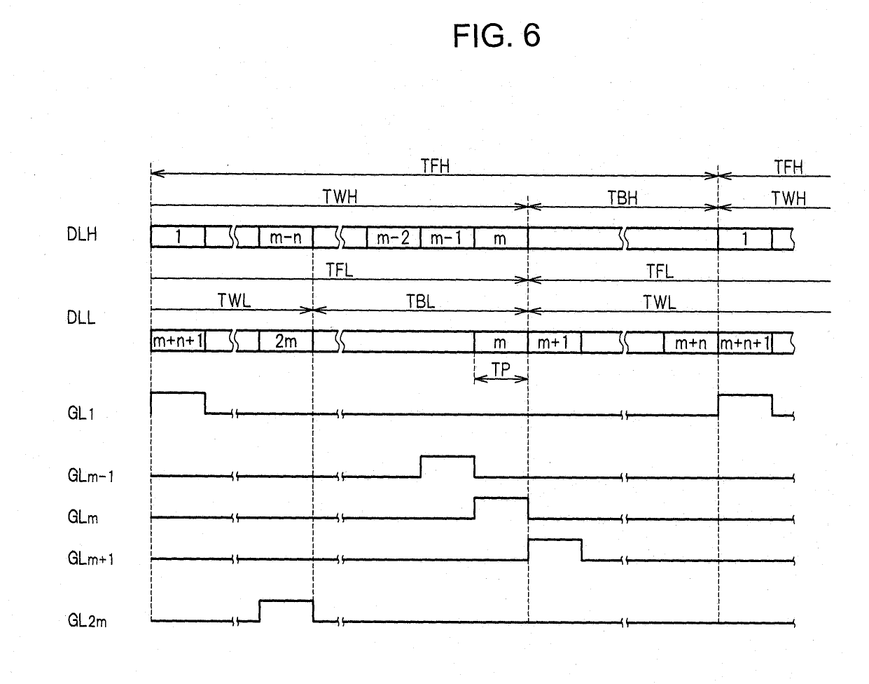

FIG. 6 is a timing chart showing timing of various signals used in the second embodiment, and corresponds to FIG. 4 showing the timing of various signals used in the first embodiment. In the drawing, time is taken on an axis of abscissas. In the drawing, a display data signal supplied to the upper data signal line DLH, a display data signal supplied to the lower data signal line DLL, a selection signal supplied to the scanning line GL₁, a selection signal supplied to the scanning line a selection signal supplied to the scanning line GLₘ, a selection signal supplied to the scanning line GLₘ₊₁, and a selection signal supplied to the scanning line GL₂ₘ are shown in order from the top.

A driving method of the upper divided display section DAH is explained hereinafter. During a writing period TWH in an arbitrary frame period TFH, the vertical drive circuit YDV sequentially selects the scanning lines GL from the first scanning line GL₁ to the last scanning line GLₘ in the upper divided display section DAH. Next, the next frame period TFH comes after the vertical blanking period TBH, and the selection of the scanning lines GL in the writing period TWH is repeated starting from the scanning line GL₁ again. During the writing period TWH, the upper data line drive circuit XDVH supplies a display data signal to be supplied to the pixel circuits PC which are connected to the scanning line GL to the upper data signal line DLH as the potential level. The driving method of the lower divided display section DAL is explained hereinafter. During a writing period TWL of an arbitrary frame period TFL, the vertical drive circuit YDV sequentially selects the scanning lines GL from the scanning line GLₘ₊₁ to the scanning line GL₂ₘ from a point of time when the vertical blanking period TBH starts after the scanning line GLₘ in the upper divided display section DAH is selected. Next, the next frame period TFL comes after the vertical blanking period TBL, and the selection of the scanning lines GL in the writing period TWL is repeated again starting from the scanning line _{GL}ₘ₊₁. During the writing period TWL, the lower data line drive circuit XDVL supplies a display data signal to be supplied to the pixel circuits PC which are connected to the scanning line GL to the lower data signal line DLL as the level of potential. The driving method by the lower data line drive circuit XDVL is substantially equal to the driving method by the upper data line drive circuit XDVH with respect to the above-mentioned points. However, the second embodiment differs from the first embodiment with respect to a point that the lower data line drive circuit XDVL outputs the pre-data signal during the pre-data signal output period TP which is within the vertical blanking period TBL and immediately before the writing period TWL of the next frame period TFL. The pre-data signal, in this embodiment, is the display data signal of the m-th row which the upper data line drive circuit XDVH outputs when the scanning line GLₘ is selected during the preceding writing period TWH. In this embodiment, a length of the pre-data signal output period TP is equal to a length of a period during which one of other scanning lines GL is selected (horizontal scanning period) .

Due to such a driving method, as in the case of the first embodiment, in the same manner as the scanning line GLₘ or the scanning line GLₘ₊₂, before the scanning line GLₘ₊₁ is selected, the display data is supplied to the lower data signal line DLL. Accordingly, it is possible to approximate the input-output characteristic between the gray level displayed by the row of the pixel circuit PC corresponding to the scanning line GLₘ and the display data signal to the input-output characteristic between another scanning line GL and the data signal. When the frame inversion driving is used, it is possible to suppress a phenomenon that a darker line is observed only on the (m₊l)-th row. In the same manner as the first embodiment, the pre-data signal is not limited to the above-mentioned signal. For example, the display data signal in the (m₊1)-th row supplied immediately after the pre-data signal input period TP may be outputted as the pre-data signal. This driving method is also applicable to the line inversion driving and the dot inversion driving instead of the frame inversion driving.

While there have been described what are at present considered to be certain embodiments of the invention, it will be understood that various modifications maybe made thereto, and it is intended that the appended claims coverall such modifications as fall within the true spirit and scope of the invention.

For example, the invention is also applicable to a liquid crystal display device adopting any other display technologies such as a TN liquid crystal display device. This is because the division driving method is also applicable to the liquid crystal display device adopting other display methods, and the task which arises when the signal potential of the data signal line changes is shared.

What is claimed is:

1. A liquid crystal display device comprising:
a drive circuit; and
a plurality of divided display sections which are arranged parallel to each other in a predetermined direction, wherein each divided display section comprises:
a plurality of scanning lines which are connected to the drive circuit;
a plurality of data signal lines which intersect with the plurality of scanning lines, and are connected to the drive circuit; and
a plurality of pixel circuits which are provided correspondingly to intersections of the scanning lines and the data signal lines, the pixel circuit displaying gray level based on a data signal which is supplied when the corresponding scanning line is selected and is supplied to the corresponding data signal line,
the drive circuit sequentially selects the plurality of scanning lines included in each divided display section from the first scanning line, supplies the data signal to the data signal line included in the divided display section, and repeats the operations from the first scanning line with a lapse of a predetermined period after selecting the last scanning line, and
the drive circuit supplies a signal potential to the data signal line based on the data signal before selecting the first scanning line which is included in at least one of the divided display sections and is arranged adjacent to the scanning line included in another divided display section and within the predetermined period.

2. The liquid crystal display device according to claim 1, wherein
the plurality of scanning lines included in each divided display section are arranged in the predetermined direction in order that the scanning lines are selected by the drive circuit, and
the drive circuit supplies the signal potential to the data signal line which is included in one or more of the divided display section based on the data signal which is supplied at the time of selecting at least one of the scanning lines included in another divided display section before selecting the first scanning line which is included in the one or more of the divided display sections and is arranged adjacent to the scanning line included in the another divided display section and within the predetermined period.

3. The liquid crystal display device according to claim 2, wherein
the drive circuit supplies the signal potential to the data signal line which is included in one or more of the divided display section based on the data signal which is supplied at the time of selecting the last scanning line which is included in another divided display section before selecting the first scanning line which is included in the one or more of the divided display sections and is arranged adjacent to the scanning line included in the another divided display section and within the predetermined period.

4. The liquid crystal display device according to claim 1, wherein
the drive circuit supplies the signal potential to the data signal line which is included in one or more of the divided display section based on the data signal which is supplied at the time of selecting the first scanning line which is included in the one or more of the divided display sections and is arranged adjacent to the scanning line included in another divided display section before selecting the first scanning line and within the predetermined period.
